(19) United States
(12) Patent Application Publication
(10) Pub. No.: US 2015/0164717 A1
(43) Pub. Date: Jun. 18, 2015

(54) SELF OPERABLE WHEELCHAIR

(71) Applicant: MEDICRAFT HOLDINGS (TAIWAN) CO., LTD, Taipei City (TW)

(72) Inventor: Tun-Chi LEE, New Taipei City (TW)

(73) Assignee: MEDICRAFT HOLDINGS (TAIWAN) CO., LTD, Taipei City (TW)

(21) Appl. No.: 14/338,405

(22) Filed: Jul. 23, 2014

(30) Foreign Application Priority Data
Dec. 12, 2013 (TW) 102145951

(51) Int. Cl. A61G 5/04; A61G 5/12; G05D 1/02; A61G 5/10

(52) U.S. Cl. CPC A61G 5/041; A61G 5/1002; A61G 5/12; A61G 5/1059; G05D 1/0212; A61G 2005/125; A61G 2005/127

(57) ABSTRACT

A self operable wheelchair includes a chair body having several wheels for moving about; a power module coupled electrically to one wheel of the chair body for supplying power; a processing module coupled electrically to the power module for processing one route data and converting into a control signal transmitted to the power module for controlling activation of the chair body; a memory module for storing and transmitting the route data to the processing module; a detection module capable of detecting the route data of the chair body and transmitting the route data via the processing module to store within the memory module; and an operation module for transmitting an operation signal to the processing module, which, in turn, activates the chair body based on the operation signal.

### CROSS-REFERENCES TO RELATED APPLICATION

This application claims the priority of Taiwanese patent application No. 102145951, filed on Dec. 12, 2013, which is incorporated herewith by reference.

### BACKGROUND OF THE INVENTION

1. Field of the Invention

The present invention relates generally to a wheelchair, and more particularly to a self operable wheelchair and the system thereof.

2. the Prior Arts

There are two types of conventional wheelchairs, wherein one is manually operated while the other one is mechanically operated. The mechanically operated wheelchair is not discussed herein. There is yet another type of wheelchair, namely battery operated wheelchair, which traveling direction is determined by the operator, that is the seated person in the wheelchair and the power for moving the wheelchair is supplied by the battery.

Since the conventional battery operated wheelchair requires the rider to manipulate the operation knob, it brings several inconveniences for those disabled persons, like suffering from muscle atropy, arthritis or spinal cord damage. Owing to the reasons that severely disabled persons cannot operate the operation knob manually and conveniently, undesired accidents may occur and hence leading to dangerous environment when using the conventional battery operated wheelchair. Even if the disabled person can operate the wheelchair with great difficulties, encountering the undesired accidents is still unavoidable.

### SUMMARY OF THE INVENTION

For those severely disabled persons having difficulties to operate the wheelchair, a wide range of scope is still possible for every inventor to develop a self operable wheelchair.

A primary objective of the present invention is to provide a self operable wheelchair that includes: a chair body having a plurality of wheels for moving about, a seat, a pair of armrests, a backrest, a frame and a toilet access, wherein the seat is adapted to be seated over a toilet once the toilet is received in the toilet access; a power module coupled electrically to at least one of the wheels for supplying power to move the chair body; a processing module coupled electrically to the power module for processing at least one route data and converting the same into a control signal transmitted to the power module for controlling activation of the chair body; a memory module coupled electrically to the processing module for storing and transmitting the route data to the processing module; a detection module coupled electrically to the processing module and capable of detecting the route data of the chair body and transmitting the route data via the processing module so as to store within the memory module; and an operation module coupled electrically to or remotely to the processing module for directly transmitting an operation signal to the processing module, which, in turn, activates the chair body based on the operation signal.

In the above wheelchair, an operation mode of the power module is detected by the detecting module while the processing module is capable of storing at least one the route data within the memory module so as to permit the operation module to select a respective one of the route data from the memory module for transmitting the control signal corresponding to the respective one of the route data to the power module such the chair body is driven based on the route data.

Preferably, the seat is operable by the processing module in such a manner to uncover and expose the toilet access or rotatable relative the frame so as to be lifted upward from the frame.

To be more specific, the seat has left and right seat parts disposed side by side above the frame and are adapted to be separated relative to each other along a horizontal direction so as to expose the toilet access. Under this condition, the user can use the toilet.

In addition, the armrests are movable relative to the backrest manually or via the process module.

To be more specific, the armrests are movable relative to the backrest between a first position, where the armrests extend perpendicularly and outwardly from the backrest and a second position, where the armrest are generally flush with the backrest. Under this condition, the user can take a bath similar to an ordinary person.

Preferably, the seat has a front end connected pivotally to the frame and a rear end connected pivotally to the backrest. The frame further includes first and second lifting structures installed at a predetermined position of the chair body such that the first and second lifting structures are adapted to be activated by the processing module to align the seat and the backrest relative to each other. Under this condition, the back of the disabled person is supported by the assembly of the seat and the backrest so as to permit standing.

The self operable wheelchair of the present invention further includes a knee support unit of airbag type installed in the chair body and connected to an air pump, which is operable manually or by the processing module.

To be more specific, the knee support unit includes left and right knee airbag supports respectively for supporting the left and right legs of the disabled person during riding or standing actions.

In this embodiment, the power module further includes a first power module and a second power module. The plurality of wheels includes a first pair of wheels operable by the first power module and a second pair of wheels operable by the second power module via the detection module.

A self operable wheelchair system of the present invention includes: a chair body having a plurality of wheels for moving about, a seat, a pair of armrests, a backrest, a frame and a toilet access, wherein the seat is adapted to be seated over a toilet once the toilet is received in the toilet access; a power module coupled electrically to at least one of the wheels for supplying power to move the chair body; a processing module coupled electrically to the power module for processing at least one route data and converting the same into a control signal transmitted to the power module for controlling activation of the chair body; a memory module coupled electrically to the processing module for storing and transmitting the route data to the processing module; a detection module coupled electrically to the processing module and capable of detecting the route data of the chair body and transmitting the route data via the processing module so as to store within the memory module; an operation module coupled electrically to or remotely coupled to the processing module for directly transmitting an operation signal to the processing module, which, in turn, activates the chair body based on the operation signal; and a position correcting module capable of recognizing an initial position of the chair body, which, in turn, is detected and memorized by the detection module.

In the above wheelchair system, the processing module is capable of sensing an operation mode of the power module through the detection module and recognizing the initial position of the chair body through the position correction module and combining both so as to form the route data and storing in the memory module. Upon desired, the operation module is capable of selecting a respective one of the route data from the memory module for transmitting the control signal corresponding to the respective one of the route data to the power module such the chair body is driven based on the respective one of the route data, thereby permitting entry of the toilet into the toilet access such that the seat is seated over the toilet.

Preferably, the seat is operable by the processing module in such a manner to uncover and expose the toilet access or rotatable relative the frame so as to be lifted upward from the frame.

To be more specific, the seat has left and right seat parts disposed side by side above the frame and are adapted to be separated relative to each other along a horizontal direction so as to expose the toilet access. Under this condition, the user can use the toilet.

In addition, the armrests are movable relative to the backrest manually or via the process module.

To be more specific, the armrests are movable relative to the backrest between a first position, where the armrests extend perpendicularly and outwardly from the backrest and a second position, where the armrest are generally flush with the backrest. Under this condition, the user can take a bath similar to an ordinary person.

Preferably, the seat has a front end connected pivotally to the frame and a rear end connected pivotally to the backrest. The frame further includes first and second lifting structures installed at a predetermined position of the chair body such that the first and second lifting structures are adapted to be activated by the processing module to align the seat and the backrest relative to each other. Under this condition, the back of the disabled person is supported by the assembly of the seat and the backrest so as to permit standing.

The self operable wheelchair system of the present invention further includes a knee support unit of airbag type installed in the chair body and connected to an air pump, which is operable manually or by the processing module.

To be more specific, the knee support unit includes left and right knee airbag supports respectively for supporting the left and right legs of the disabled person during riding or standing actions.

In this embodiment, the operation module further includes a remote control compatible with one of WIFI, infrared, Bluetooth wireless systems for establishing communication with the chair body.

Preferably, the position correcting module includes at least one magnetic stone. The detection module is capable of detecting varying magnetic field of the magnetic stone.

Preferably, the position correction module includes at least one electromagnetic sensing element. The detection module is capable of detecting varying magnetic field of the electromagnetic sensing element.

In one embodiment, an infrared sensing device serves as the electromagnetic sensing element. The detection module is capable of detecting varying infrared signal of the infrared sensing device.

Preferably, the position correcting module further includes an image recognition element. The detection module is capable of detecting and recognizing corresponding image data of the image recognition element.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a diagram representing elements of a self operable wheelchair of the present invention;

FIG. 2 shows a perspective view of the self operable wheelchair of the present invention;

FIG. 3 shows a perspective view of the self operable wheelchair of the present invention, in which a toilet access of the wheelchair is exposed;

FIG. 4 shows a lateral side view of the self operable wheelchair of the present invention, in which first and second lifting structures are shown in use;

FIG. 5 shows a diagram representing elements of a self operable wheelchair system of the present invention;

FIG. 6 shows a planar view illustrating how the wheelchair of the present invention is guided from its initial position into a designated position;

FIGS. 7˜10 respectively illustrate how the wheelchair of the present invention is guided from its initial position into a toilet by utilizing a position correcting module employed in the wheelchair; and

FIGS. 11 and 12 respectively illustrate how the wheelchair of the present invention is guided from its initial position into a bathroom by utilizing the position correcting module employed in the wheelchair.

### DETAILED DESCRIPTION OF THE PREFERRED EMBODIMENT

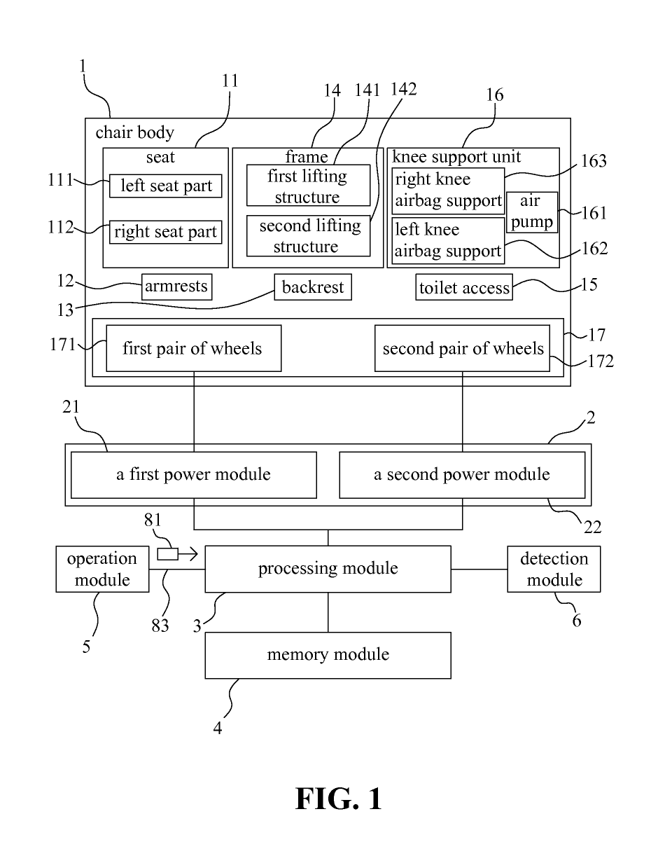

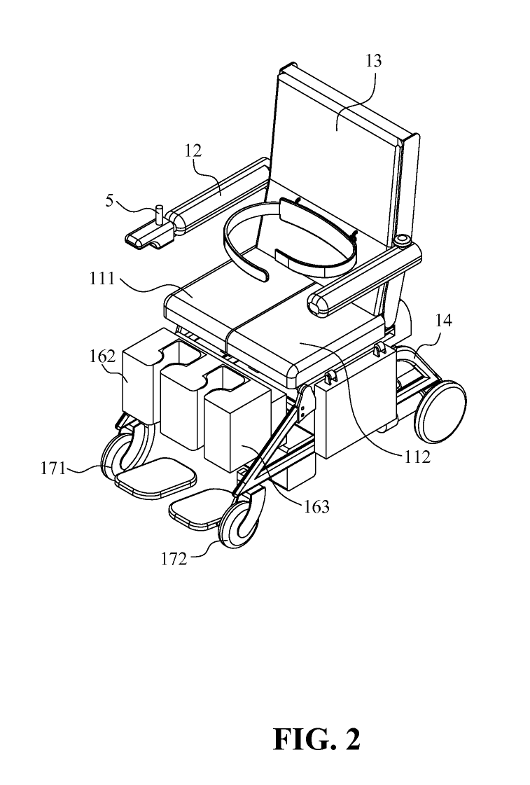

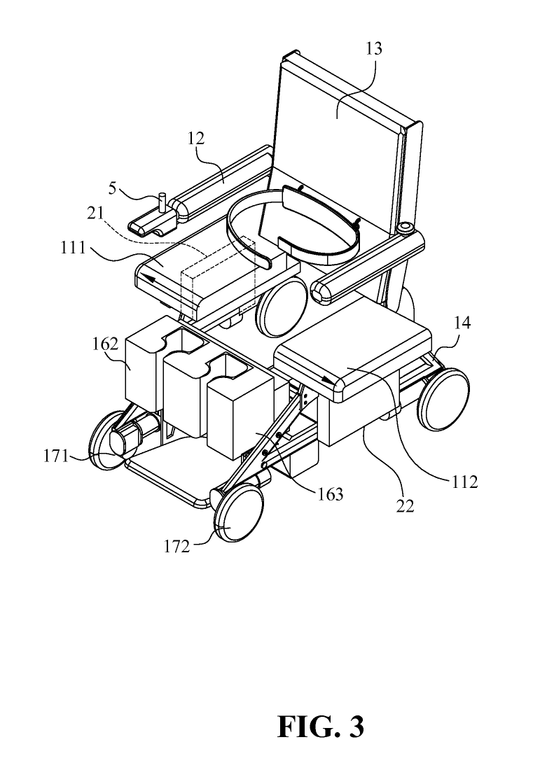

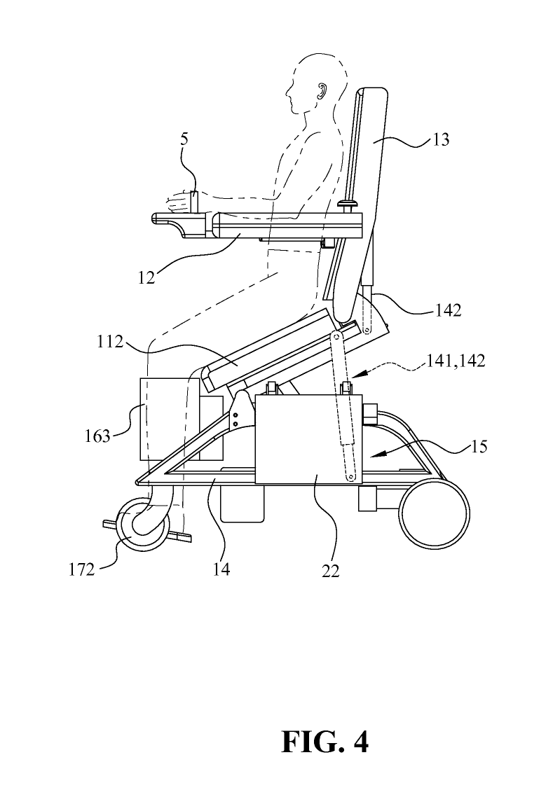

Referring to FIGS. 1˜4, wherein FIG. 1 shows a diagram representing elements of a self operable wheelchair of the present invention; FIG. 2 shows a perspective view of the self operable wheelchair of the present invention; FIG. 3 shows a perspective view of the self operable wheelchair of the present invention, in which a toilet access of the wheelchair is exposed; and FIG. 4 shows a lateral side view of the self operable wheelchair of the present invention, in which first and second lifting structures are shown in use.

As best shown in FIGS. 1 and 2, the self operable wheelchair of the present invention includes a chair body 1, a power module 2, a processing module 3, a memory module 4, a detection module 6 and an operation module 5.

The chair body 1 includes a plurality of wheels 17 for moving about, a frame 14, a seat 11 and a backrest 13 mounted on the frame 14, a pair of armrests 12 mounted pivotally on the backrest 13, and a toilet access 15, wherein the frame 14 defines the toilet access 15 below the seat 11 such that the seat 11 is adapted to be located over a toilet 93 once the toilet 93 is received in the toilet access 15 by moving the wheelchair as shown in FIG. 8.

The power module 2 is coupled electrically to at least one of the wheels 17 for supplying power to move the chair body 1.

The processing module 3 is coupled electrically to the power module 2 for processing at least one route data 91 and converting the same into a control signal transmitted to the power module 2 for controlling activation of the chair body 1.

The memory module 4 is coupled electrically to the processing module 3 for storing and transmitting the route data 91 to the processing module 3.

The detection module 6 is coupled electrically to the processing module 3 and is capable of detecting the route data 91 of the chair body 1 and transmits the route data 91 via the processing module 3 so as to store within the memory module 4.

The operation module 5 is coupled electrically to or remotely to the processing module 3 for directly transmitting an operation signal 81 to the processing module 3, which, in turn, activates the chair body 1 via the gear mechanism based on the operation signal 81.

In the present embodiment, an operation mode of the power module 2 is detected by the detecting module 4 while the processing module 3 is capable of storing at least one the route data 91 within the memory module 4 so as to permit the operation module 5 to select a respective one of the route data 91 from the memory module 4 for transmitting the control signal corresponding to the respective one of the route data 91 to the power module 2 such the chair body 1 is driven based on the route data 91.

The seat 11 has left and right seat parts 111, 112 disposed side by side above the frame 14 and are operable by the operation module 5, which transmits an operation signal to the processing module 3 in such a manner that the left and right seat parts 111, 112 are moved by the power module 2 so as to be separated relative to each other along a horizontal direction so as to expose the toilet access 15 (see FIG. 3). Under this condition, the operator of the wheelchair of the present invention can use the toilet 93 (see FIG. 9).

More preferably, the seat 11 has a front end connected pivotally to the frame 14 and a rear end connected pivotally to the backrest 13. The frame 14 further includes first and second lifting structures 141, 142 installed at a predetermined position of the chair body 1 such that the first and second lifting structures 141, 142 are adapted to be activated by the processing module 3 to form a desired angle between the seat 11 and the backrest 12 as best shown in FIG. 4 so as to assist the user to stand up or making proper body adjustment. To be more specific, the first and second lifting structures 141, 142 are telescopically connected hydraulic tubes having upper ends connected pivotally to the backrest 13 and lower ends connected pivotally to the frame 14 in such a manner that the first and second lifting structures 141, 142 are adapted to be activated by the processing module 3 to form a desired angle between the seat 11 and the backrest 13 or align the seat 11 and the backrest 13 relative to each other, in turn, assists the disabled person to standup while holding the armrests 12 (see FIG. 4). Also note that the backrest 13 is constructed ergonomically so as to form comfortable back support for the user.

The wheelchair of the present invention further includes a knee support unit 16 of airbag type installed in the chair body 1 and connected to an air pump 161, which is operable manually or by the processing module 3.

To be more specific, the knee support unit 16 includes left and right knee airbag supports 162, 163 which grip the left and right legs of the user to provide additional support to the disabled person while he tries to stand up.

In this embodiment, the power module 2 further includes a first power module 21 and a second power module 22. The plurality of wheels 17 includes a first pair of wheels 171 operable by the first power module 21 and a second pair of wheels 172 operable by the second power module 22 via the detection module 6.

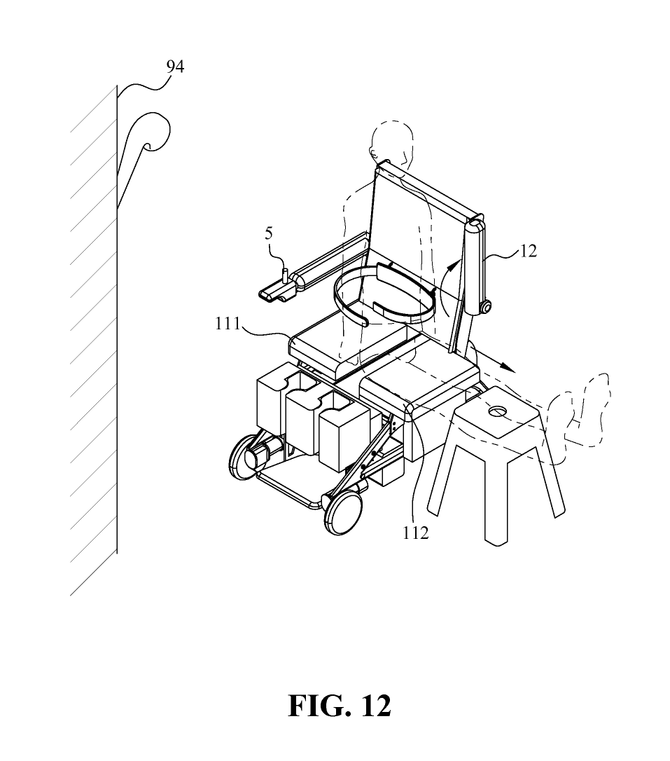

The armrests 12 are movable relative to the backrest 13 manually or via the processing module 3. To be more specific, the armrests 12 are movable relative to the backrest 13 to a first position, where the armrests 12 extend perpendicularly and outwardly from the backrest 13, as best shown in FIG. 2. At the first position, if he wishes, the disabled person can rest his arms thereon while the seat 11 and the backrest 13 are simultaneously lifted upward by the first and second lifting structures 141, 142, thereby assisting the disabled person to stand up. Alternately, the armrests 12 are movable relative to the backrest 13 to a second position, where the armrests 12 are generally flush with the backrest 13. FIG. 12 illustrates one armrest 12 is located at the second position, the disabled person (shown by dotted lines) can lean his body on the other armrest 12 while he uses the toilet or taking a shower.

An important aspect to note is that in order to permit access of the toilet 93 (see FIG. 9) into the toilet access 15, the frame 14 defines a hollow space below the seat 11 and the power module 2 is installed at lateral side of the chair body 1 while the other modules are also installed in the same manner.

Another important aspect to note is that the processing module 3 includes a processor for processing the route data 91, thereby converting into the control signal 82 for inputting into the power module 2 to control the activation of the chair body 1.

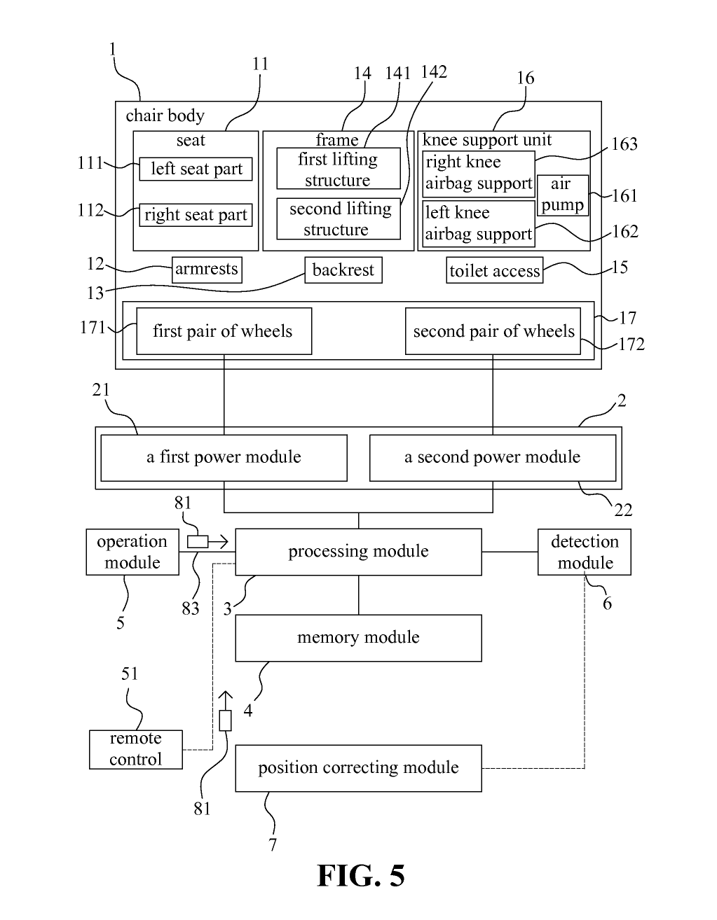

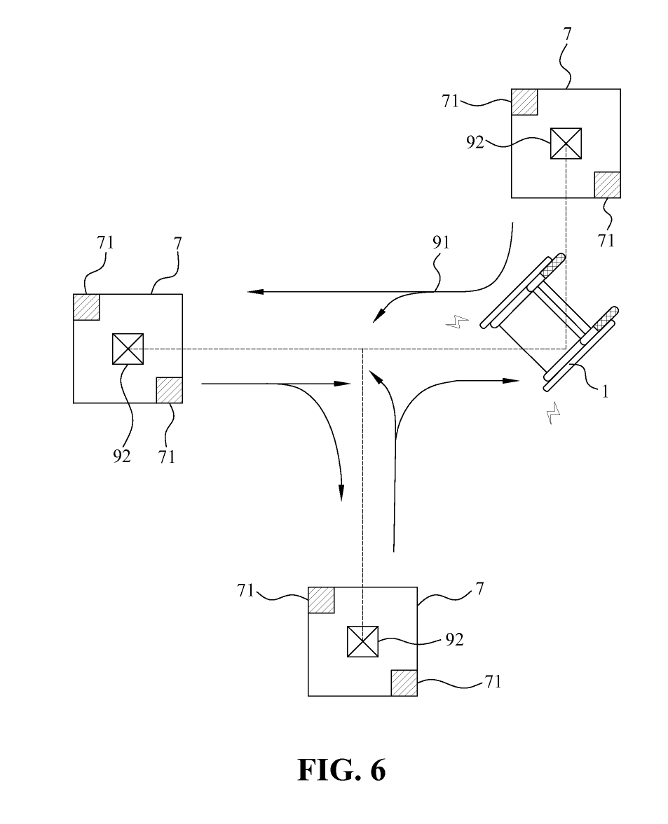

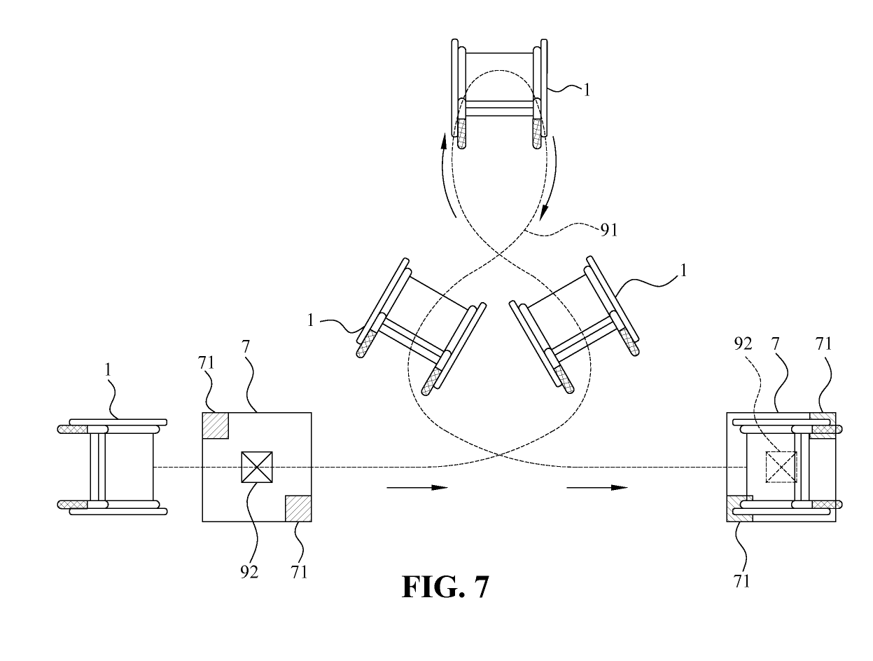

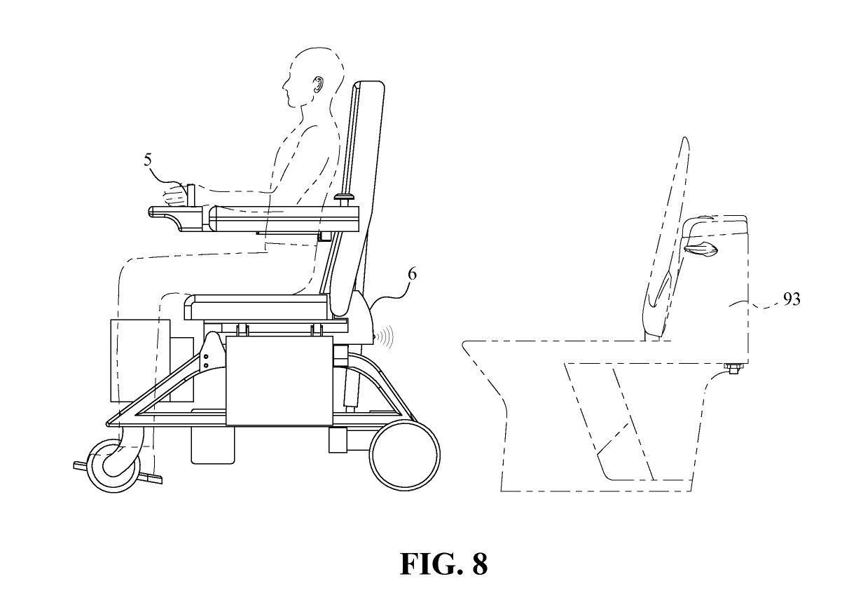

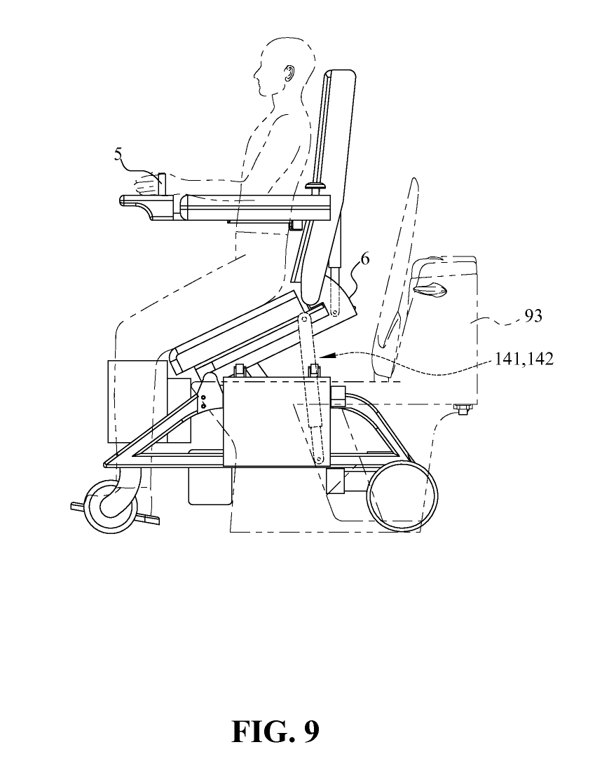

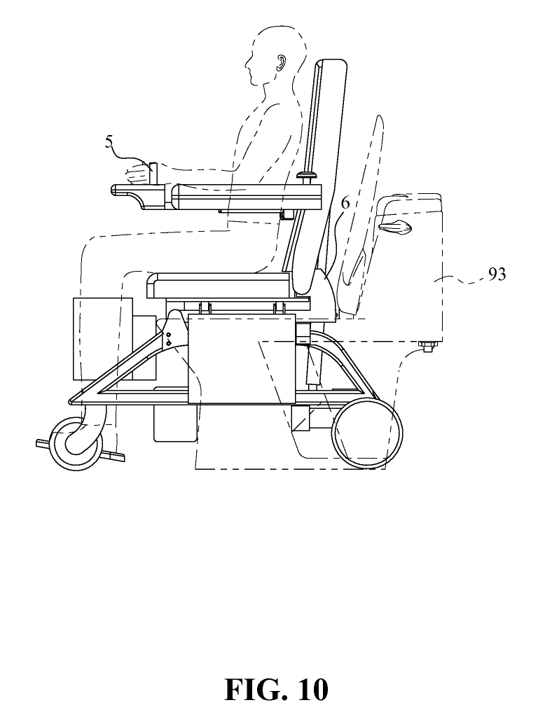

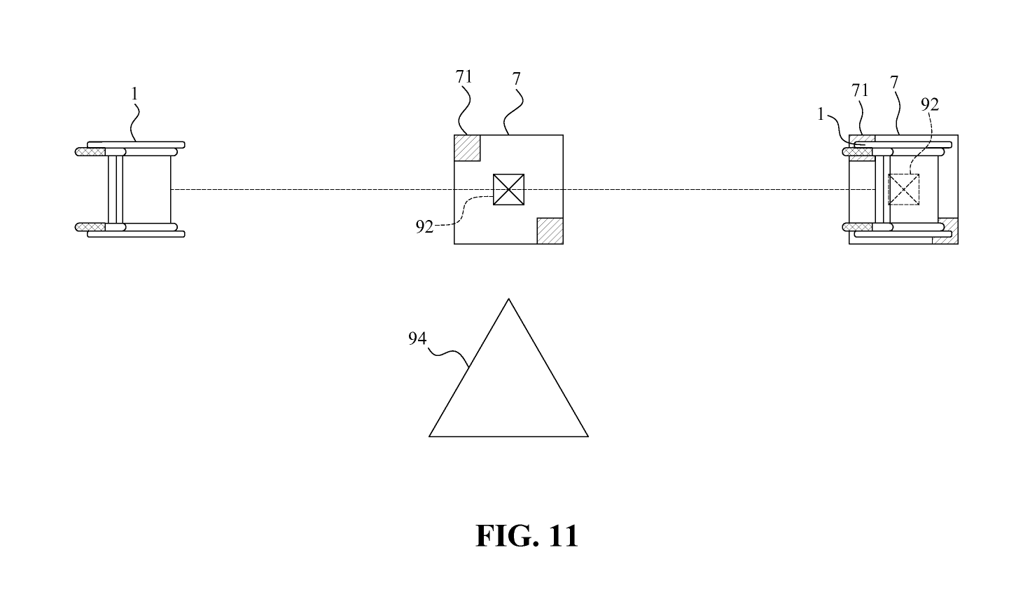

Referring to FIGS. 5 to 12, wherein FIG. 5 shows a diagram representing elements of a self operable wheelchair system of the present invention; FIG. 6 shows a planar view illustrating how the wheelchair of the present invention is guided from its initial position into a designated position; FIGS. 7˜10 respectively illustrate how the wheelchair of the present invention is guided from its initial position into a toilet by utilizing a position correcting module employed in the wheelchair; and FIGS. 11 and 12 respectively illustrate how the wheelchair of the present invention is guided from its initial position into a bathroom by utilizing the position correcting module employed in the wheelchair.

The self operable wheelchair system of the present invention includes the above elements and their functions are the same so that a detailed description thereof is omitted herein for the sake of brevity. However, the wheelchair system of the present invention further includes a position correcting module 7 capable of recognizing an initial position of the chair body 1, which, in turn, is detected and memorized by the detection module 6.

Referring to FIG. 6, in this embodiment, the processing module 3 is capable of sensing an operation mode of the power module 2 through the detection module 6 and recognizing the initial position 92 of the chair body 1 through the position correction module 7 and combining both so as to form the route data 91 and storing in the memory module 4. Upon desired, the operation module 5 is capable of selecting a respective one of the route data 91 from the memory module 4 for transmitting the control signal 81 corresponding to the respective one of the route data 91 to the power module 2 such the chair body 1 is driven based on the respective one of the route data, thereby permitting the chair body 1 to move along a preset route. Preferably, the position correcting module 7 includes at least one electromagnetic sensing element. The detection module 6 is capable of detecting varying magnetic field of the electromagnetic sensing element so as to determine the initial position of the chair body 1. An infrared sensing device can serve as the electromagnetic sensing element. The detection module is capable of detecting varying infrared signal of the infrared sensing device. In this embodiment, the position correction module 7 includes a magnetic stone 71 and the detection module 6 is capable of detecting varying magnetic field of the magnetic stone 71 so as to determine the initial position 92 of the chair body 1. Preferably, the position correcting module 7 further includes an image recognition element. The detection module 6 is capable of detecting and recognizing corresponding image data of the image recognition element. The image data may include the ceiling structure or flooring structure upon which the chair body 1 moves about.

FIGS. 7˜10 respectively illustrate how the wheelchair of the present invention is guided from its initial position 92 into a toilet by utilizing the position correcting module 7. In this embodiment, two position correcting modules 7 are used such that upon the chair body 1 is moved to a first position correcting module 7, the chair body 1 senses the initial position 92 owing to the route data 91 which is stored in advance and continues its traveling action until it reaches to an another position correcting module 7, where the chair body 1 senses another initial position 92, that is the chair body 1 is by this time is located above the toilet 93 (the designated position). In other words, movement of the chair body 1 along the predetermined path permit the toilet 93 to extend into the toilet access 15 of the chair body 1. To facilitate extension of the toilet 93 into the toilet access 15, the disabled person can operate the operation module 5 so as to activate the first and second lifting structures 141, 142 such that the seat 11 as well as the backrest 13 are simultaneously lifted upward to as to permit and facilitate extension of the toilet 93 into the toilet access 15 (see FIG. 9). Afterward, the first and second lifting structures 141, 142 can be lowered so as to dispose the seat 11 stably above the toilet 93. At this time, the operation module 5 is again manipulated in such a manner to move the left and right seat parts 111, 112 away from each other so as to expose the toilet 93, thereby facilitating the disabled person to use the toilet 93.

FIGS. 11 and 12 respectively illustrate how the wheelchair of the present invention is guided from its initial position into a bathroom by utilizing the position correcting module employed in the wheelchair. In the same manner, more than two position correcting modules 7 are used such that upon the chair body 1 is moved to the designated position, the disabled person can manipulate the operation module 5 in such a manner to rotate the armrests 12 relative to the backrest 13 between first and second positions. In other words, one armrest 12 can be rotated to the first position while the other armrest 12 can be rotated to the second position as best shown in FIG. 12. At this time, the disabled person can stretch his legs over a nearby chair (as shown by dotted lines), thereby facilitating the disabled person to take a shower upon opening the water tap 94.

An import aspect to note is that the operation module 5 further includes a remote control compatible with one of WIFI, infrared, Bluetooth wireless systems for establishing communication with the chair body 1 such that movement of the chair body 1 can be easily controlled by the disabled person using the remote control.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A self operable wheelchair comprising:
a chair body including a plurality of wheels for moving about, a seat, a pair of armrests, a backrest, a frame and a toilet access, wherein said seat is adapted to be seated over a toilet once the toilet is received in said toilet access;
a power module coupled electrically to at least one of said wheels for supplying power to move said chair body;
a processing module coupled electrically to said power module for processing at least one route data and converting the same into a control signal transmitted to said power module for controlling activation of said chair body;
a memory module coupled electrically to said processing module for storing and transmitting said route data to said processing module;
a detection module coupled electrically to said processing module and capable of detecting said route data of said chair body and transmitting said route data via said processing module so as to store within said memory module; and
an operation module coupled electrically to or remotely to said processing module for directly transmitting an operation signal to said processing module, which, in turn, activates said chair body based on said operation signal;
wherein, an operation mode of said power module is detected by said detecting module while said processing module is capable of storing at least one said route data within said memory module so as to permit said operation module to select a respective one of said route data from said memory module for transmitting said control signal corresponding to said respective one of said route data to said power module such said chair body is driven based on said route data.

2. The self operable wheelchair according to claim 1, wherein said seat is operable by said processing module in such a manner to uncover and expose said toilet access or rotatable relative said frame so as to be lifted upward from said frame.

3. The self operable wheelchair according to claim 2, wherein said seat has left and right seat parts disposed side by side above said frame and are adapted to be separated relative to each other along a horizontal direction so as to expose the toilet access.

4. The self operable wheelchair according to claim 1, wherein said pair of armrests are movable relative to said backrest manually or via said process module.

5. The self operable wheelchair according to claim 4, wherein said pair of armrests are movable relative to said backrest between a first position, where said armrests extend perpendicularly and outwardly from said backrest and a second position, where said armrest are generally flush with said backrest.

6. The self operable wheelchair according to claim 1, wherein said seat has a front end connected pivotally to said frame and a rear end connected pivotally to said backrest, said frame further including first and second lifting structures installed at a predetermined position of said chair body such that said first and second lifting structures are adapted to be activated by said processing module to align said seat and said backrest relative to each other.

7. The self operable wheelchair according to claim 1, further comprising a knee support unit of airbag type installed in said chair body and connected to an air pump, which is operable manually or by said processing module.

8. The self operable wheelchair according to claim 7, wherein said knee support unit includes left and right knee airbag supports.

9. The self operable wheelchair according to claim 1, wherein said power module further includes a first power module and a second power module, said plurality of wheels including a first pair of wheels operable by said first power module and a second pair of wheels operable by said second power module via said detection module.

10. A self operable wheelchair system comprising:
a chair body including a plurality of wheels, a seat, a pair of armrests, a backrest, a frame and a toilet access, wherein said seat is adapted to be seated over a toilet once the toilet is received in said toilet access;
a power module coupled electrically to at least one of said wheels for supplying power so as to move said chair body about;
a processing module coupled electrically to said power module for processing at least one route data and converting the same into a control signal transmitted to said power module for controlling activation of said chair body;
a memory module coupled electrically to said processing module for storing and transmitting said route data to said processing module;
a detection module coupled electrically to said processing module and capable of detecting said route data of said chair body and transmitting said route data via said processing module so as to store within said memory module;
an operation module coupled electrically to or remotely coupled to said processing module for directly transmitting an operation signal to said processing module, which, in turn, activates said chair body based on said operation signal; and
a position correcting module capable of recognizing an initial position of said chair body, which, in turn, is detected and memorized by said detection module;
wherein, said processing module is capable of sensing an operation mode of said power module through said detection module and recognizing said initial position of said chair body through said position correction module and combining both so as to form said route data and storing in said memory module and wherein upon desired said operation module is capable of selecting a respective one of said route data from said memory module for transmitting said control signal corresponding to said respective one of said route data to said power module such said chair body is driven based on said respective one of said route data, thereby permitting entry of the toilet into said toilet access such that said seat is seated over the toilet.

11. The self operable wheelchair system according to claim 10, wherein said seat is operable by said processing module in such a manner to uncover said toilet access or rotatable relative said frame so as to be lifted upward from said frame.

12. The self operable wheelchair system according to claim 11, wherein said seat has left and right seat parts disposed side by side above said frame and are adapted to be separated relative to each other along a horizontal direction so as to expose the toilet access.

13. The self operable wheelchair system according to claim 10, wherein said pair of armrests are movable relative to said backrest manually or via said process module.

14. The self operable wheelchair system according to claim 10, wherein said pair of armrests are movable relative to said backrest between a first position, where said armrests extend perpendicularly and outwardly from said backrest and a second position, where said armrest are generally flush with said backrest.

15. The self operable wheelchair system according to claim 10, wherein said seat has a front end connected pivotally to said frame and a rear end connected pivotally to said backrest, said frame further including first and second lifting structures installed at a predetermined position of said chair body such that said first and second lifting structures are adapted to be activated by said processing module to align said seat and said backrest relative to each other.

16. The self operable wheelchair system according to claim 15, further comprising a knee support unit of airbag type installed in said chair body and connected to an air pump, which is operable manually or by said processing module.

17. The self operable wheelchair system according to claim 16, wherein said knee support unit includes left and right knee airbag supports.

18. The self operable wheelchair system according to claim 10, wherein said operation module further includes a remote control compatible with one of WIFI, infrared, Bluetooth wireless systems for establishing communication with said chair body.

19. The self operable wheelchair system according to claim 10, wherein said position correcting module includes at least one electromagnetic sensing element, said detection module being capable of detecting varying magnetic field of said electromagnetic sensing element.

20. The self operable wheelchair system according to claim 10, wherein said position correcting module further includes an image recognition element, said detection module being capable of detecting and recognizing corresponding image data of said image recognition element.
